(19) United States
(12) Patent Application Publication
(10) Pub. No.: US 2026/0276039 A1
(43) Pub. Date: Sep. 17, 2026

(54) BEARING DEVICE

(71) Applicant: MITSUBISHI HEAVY INDUSTRIES, LTD., Tokyo (JP)

(72) Inventors: Takuzo SHIGIHARA, Tokyo (JP); Yuki KAMEYAMA, Tokyo (JP)

(73) Assignee: MITSUBISHI HEAVY INDUSTRIES, LTD., Tokyo (JP)

(21) Appl. No.: 19/471,138

(22) PCT Filed: Apr. 16, 2024
(86) PCT No.: PCT/JP2024/015096

§ 371 Date: Sep. 30, 2025

(30) Foreign Application Priority Data
May 25, 2023 (JP) 2023-085970

(51) Int. Cl. F16C 37/00; F16C 17/02; F16C 33/10

(52) U.S. Cl. CPC F16C 37/00; F16C 17/02; F16C 33/1045; F16C 33/108; F16C 2360/44

(57) ABSTRACT

A bearing device includes bearing pads each having a sliding surface that rotatably supports a rotary shaft, and an annular housing that holds the pads arranged in a circumferential direction. The bearing pad has a pad main body having a hollow part formed inside, a lubricating oil supply path communicating with the hollow part, and a discharge opening communicating with the hollow part. The hollow part has a first wall surface on the sliding surface side and a second wall surface which is on the opposite side of the sliding surface and on which a supply opening communicating with the lubricating oil supply path is formed. The hollow part also includes a support structure that connects the wall surfaces in a non-formation region of the supply opening. The hollow part has a space part in which the support structure is not formed and which serves as a linear space.

### FIELD

The present disclosure relates to a bearing device applicable to various rotary machines, such as compressors including a centrifugal compressor and a geared compressor, and turbines for driving including a steam turbine and a gas turbine.

### BACKGROUND

To improve performance of rotary machines, there has been a demand for a bearing device that can be used under conditions of high peripheral speed and high bearing stress. When use conditions for the bearing device involve an increase in peripheral speed and bearing stress, a temperature of a bearing pad becomes high, so that the bearing pad needs to be efficiently cooled. An example of a technique of efficiently cooling the bearing pad of the bearing device is disclosed in the following Patent Literature 1.

In Patent Literature 1, an internal channel network is formed in the bearing pad, and oil for cooling is supplied to the internal channel network. The internal channel network is a branched flow path including at least one channel node in fluid communication with an opening for cooling, and at least two passages in fluid communication with the channel node.

CITATION LIST

### Patent Literature

Patent Literature 1: Japanese Translation of PCT International Application Publication No. 2019-519707

### SUMMARY

### Technical Problem

In Patent Literature 1 described above, cooling of the bearing pad is promoted by circulating the oil for cooling inside the bearing pad, but further improvement in cooling performance of the bearing pad is required.

The present disclosure has been made to solve the above-described problem, and an object thereof is to provide a bearing device capable of further improving cooling performance of a bearing pad.

### Solution to Problem

To achieve the above object, a bearing device according to the present disclosure includes: a plurality of bearing pads each having a sliding surface rotatably supports the rotary shaft; and an annular housing that holds the bearing pads arranged in a circumferential direction, At least one of the bearing pads has a pad main body, the pad main body having a hollow part formed inside, a lubricating oil supply path communicating with the hollow part, and discharge openings communicating with the hollow part. The hollow part has a first wall surface on the sliding surface side and a second wall surface which is on the opposite side of the sliding surface and on which a supply opening communicating with the lubricating oil supply path is formed. The hollow part includes a support structure that connects the first wall surface and the second wall surface in a non-formation region of the supply opening. The hollow part includes a space part in which the support structure is not formed, the space part serving as a linear space extending from the supply opening to the first wall surface in a formation region of the supply opening.

### Advantageous Effects of Invention

With the bearing device according to the present disclosure, cooling performance of the bearing pad can be further improved.

### BRIEF DESCRIPTION OF DRAWINGS

FIG. 1 is a schematic diagram of a bearing device according to a first embodiment viewed from an axial direction.

FIG. 2 is a cross-sectional view along II-II in FIG. 1 illustrating a schematic cross section of the bearing device.

FIG. 3 is a diagram illustrating temperature distribution along a circumferential direction of a bearing pad in a comparative example.

FIG. 4 is a schematic perspective view for explaining a schematic structure of the bearing pad.

FIG. 5 is a schematic cross-sectional view for explaining a hollow part of the bearing pad.

FIG. 6 is an explanatory diagram illustrating a first example of a unit structure of a support structure.

FIG. 7 is an explanatory diagram illustrating a second example of a unit structure of the support structure.

FIG. 8 is an explanatory diagram illustrating a third example of a unit structure of the support structure.

FIG. 9 is an explanatory diagram illustrating a fourth example of a unit structure of the support structure.

FIG. 10 is an explanatory diagram illustrating a fifth example of a unit structure of the support structure.

FIG. 11 is an explanatory diagram illustrating a sixth example of a unit structure of the support structure.

FIG. 12 is an explanatory diagram illustrating a seventh example of a unit structure of the support structure.

FIG. 13 is an explanatory diagram illustrating an eighth example of a unit structure of the support structure.

FIG. 14 is an explanatory diagram illustrating a ninth example of a unit structure of the support structure.

FIG. 15 is a schematic diagram illustrating a structure of a bearing pad of a bearing device according to a second embodiment.

FIG. 16 is a schematic cross-sectional view illustrating a modification of the second embodiment.

### DESCRIPTION OF EMBODIMENTS

The following describes preferred embodiments of the present disclosure in detail with reference to the drawings. The present disclosure is not limited to these embodiments, and in a case where a plurality of embodiments are provided, combinations of the respective embodiments are also included. Constituent elements in the embodiments include a constituent element easily conceivable by those skilled in the art, substantially the same constituent element, and what is called an equivalent.

### First Embodiment

### <Configuration of Bearing Device>

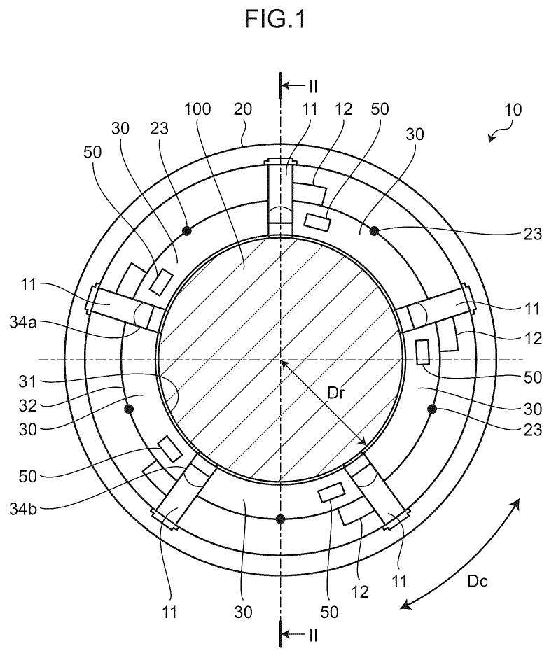

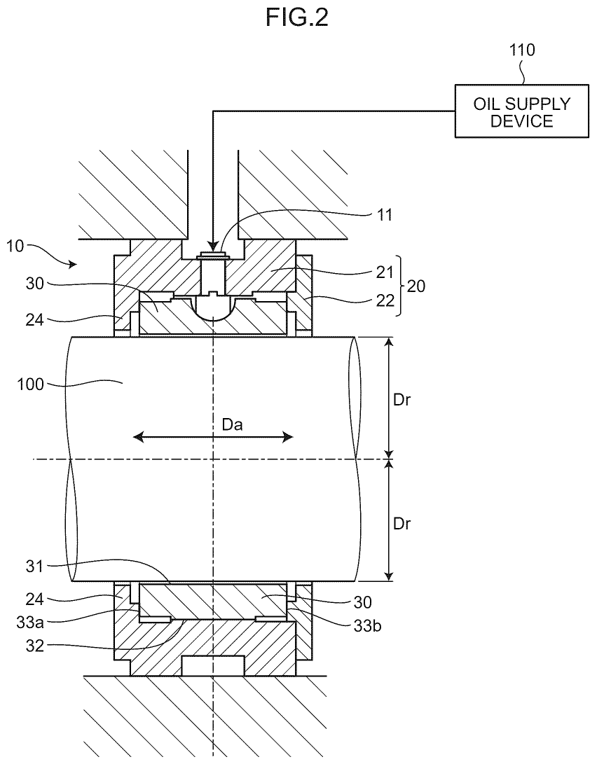

FIG. 1 is a schematic diagram of a bearing device according to a first embodiment viewed from an axial direction, and FIG. 2 is a cross-sectional view along II-II in FIG. 1 illustrating a schematic cross section of the bearing device. In the following description of the embodiments, the axial direction of the bearing device is referred to as a Da direction (refer to FIG. 2), a radial direction of the bearing device is referred to as a Dr direction, and a circumferential direction of the bearing device is referred to as a Dc direction.

A bearing device 10 supports a rotor in a rotatable manner. In the first embodiment, the rotor is a rotary shaft 100 of a rotary machine, for example. The rotary machine is a compressor such as a centrifugal compressor or a geared compressor, and a turbine for driving such as a steam turbine or a gas turbine. In the first embodiment. the bearing device 10 is a sliding bearing, and is a journal bearing that supports a load in the radial direction Dr (radial load) of the rotary shaft 100. The bearing device 10 supports the rotary shaft 100 having a cylindrical shape extending in the Da direction to be rotatable about a center axis of the rotary shaft 100.

The bearing device 10 is, for example, a tilting pad bearing. The bearing device 10 includes a housing 20 and a plurality of (five in the present embodiment) bearing pads 30. The bearing device 10 also includes a plurality of (five in the present embodiment) nozzles 11. The number of the bearing pads 30 and the nozzles 11 is not limited five, but may be equal to or smaller than four or equal to or larger than six.

The housing 20 has an annular shape. The housing 20 holds a plurality of (five) the bearing pads 30 arranged in the circumferential direction Dc. The housing 20 includes a housing main body 21 and an end face plate 22 as illustrated in FIG. 2.

The housing main body 21 has an annular shape. The housing main body 21 supports a back surface 32 of each of the bearing pads 30. The housing main body 21 includes an annular flange part 24 projecting inward in the radial direction at one end part in the axial direction Da. The flange part 24 is opposed to each bearing pad 30 in the axial direction Da. An end part on an inner peripheral side of the flange part 24 is opposed to the rotary shaft 100 with a small gap therebetween in the radial direction Dr. At another end part in the axial direction Da of the housing main body 21, the flange part 24 is not disposed but the end face plate 22 is attached. The end face plate 22 is an annular flat plate member having a shape substantially equivalent to that of the flange part 24. The end face plate 22 is opposed to each bearing pad 30 in the axial direction Da. An end part on the inner peripheral side of the end face plate 22 is opposed to the rotary shaft 100 with a small gap therebetween in the radial direction Dr. In a state where the rotary shaft 100 is inserted, the housing 20 forms a space between an outer peripheral surface of the rotary shaft 100 and an inner peripheral surface of the housing 20, the space for housing the bearing pads 30 and retaining lubricating oil.

As illustrated in FIG. 1, the five bearing pads 30 are arranged in the circumferential direction Dc to surround the rotary shaft 100 over the entire circumference. Each of the five bearing pads 30 is opposed to the rotary shaft 100 in the radial direction Dr at a predetermined interval, and supports the rotary shaft 100.

The bearing pad 30 has an arc shape. The bearing pad 30 has a sliding surface 31 that is opposed to an outer surface of the rotary shaft 100 and rotatably supports the rotary shaft 100, a back surface 32 on the opposite side of the sliding surface 31, a pair of side surfaces 33a and 33b (refer to FIG. 2) in a width direction (axial direction Da), and a pair of end faces 34a and 34b in the circumferential direction Dc. As illustrated in FIG. 1 and FIG. 2, the width direction of each bearing pad 30 coincides with the axial direction Da of the bearing device 10 (rotary shaft 100), a thickness direction of each bearing pad 30 coincides with the radial direction Dr of the bearing device 10 (rotary shaft 100), and a length direction of each bearing pad 30 coincides with the circumferential direction Dc of the bearing device 10 (rotary shaft 100).

The sliding surface 31 is an inner peripheral surface of the bearing pad 30, and is a curved surface having a radius of curvature that is the same as or slightly larger than a radius of curvature of the outer peripheral surface of the rotary shaft 100. The back surface 32 is an outer peripheral surface of the bearing pad 30, and is a curved surface along an inner peripheral surface of the housing main body 21. The one side surface 33a and the other side surface 33b are planes, and are opposed to the flange part 24 and the end face plate 22, respectively, in the axial direction Da. The pair of end faces 34a and 34b in the circumferential direction Dc are planes. The five bearing pads 30 have substantially the same shape.

The bearing pad 30 is swingably disposed around an axis parallel to the Da direction with a pivot 23 as a fulcrum at a center part of a back surface 32. That is, the bearing pad 30 can be slightly inclined with the pivot 23 as a fulcrum within a predetermined angular range with respect to the outer peripheral surface of the rotary shaft 100.

The five nozzles 11 are disposed in the circumferential direction Dc, one between each adjacent pair of the five bearing pads 30. The nozzle 11 passes through the housing 20 in the radial direction Dr. The nozzle 11 is connected to an oil supply device 110 (refer to FIG. 2) via an oil supply path. The nozzle 11 discharges lubricating oil toward a center in the radial direction Dr (that is, the rotary shaft 100) within the housing 20. Due to this, each of the nozzles 11 supplies the lubricating oil from the outside of the bearing pad 30 (a pad main body 40 described later) to the sliding surface 31. Each nozzle 11 forms, by the discharged lubricating oil, an oil film of the lubricating oil in a gap between the sliding surface 31 of each bearing pad 30 and the outer peripheral surface of the rotary shaft 100. As the rotary shaft 100 rotates, the bearing device 10 generates fluid pressure in the oil film between the outer peripheral surface of the rotary shaft 100 and the sliding surface 31, and generates a supporting force for a radial load by the fluid pressure.

### <Explanation of Heating Phenomenon of Bearing Pad>

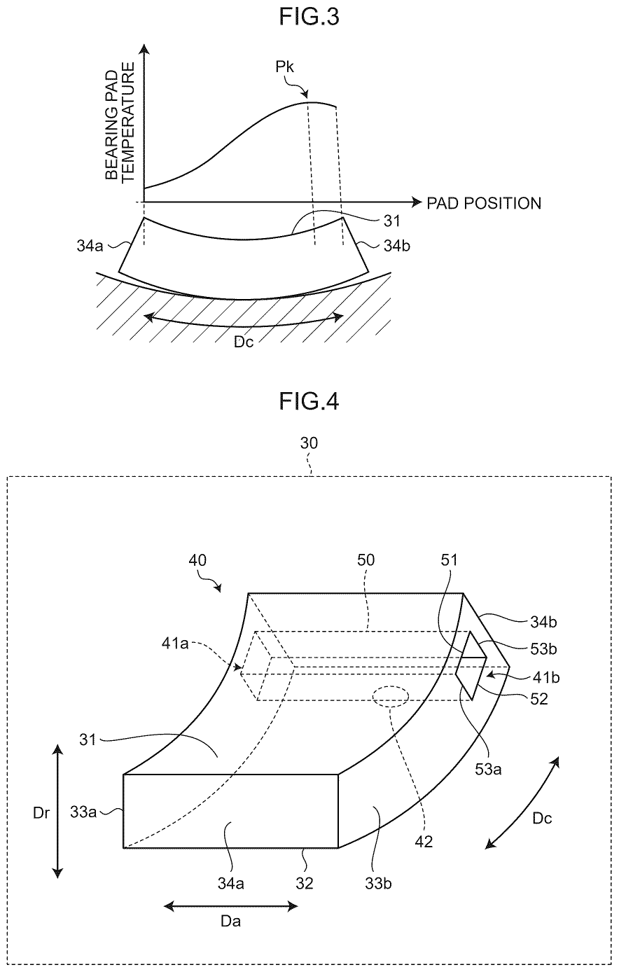

Herein, the bearing pad 30 is heated by shearing heat generation of the oil film between the sliding surface 31 and the rotary shaft 100, and a temperature of the sliding surface 31 particularly rises. FIG. 3 is a diagram illustrating temperature distribution along the circumferential direction Dc of the bearing pad in a comparative example, and illustrates a graph corresponding to a cross section of the bearing pad. The bearing pad in the comparative example has the same external shape as that of the bearing pad 30, but does not have a cooling structure described later.

In FIG. 3, a vertical axis in the graph indicates a sliding surface temperature of the bearing pad, and a horizontal axis indicates a position of the bearing pad in the circumferential direction Dc. A direction from the end face 34a toward the end face 34b (counterclockwise direction) is a rotation direction of the rotary shaft 100. As it goes toward the rotation direction side (toward the end face 34b side), a heat generation amount of the bearing pad increases and the temperature rises. The temperature (heat generation amount) reaches a maximum at a peak position Pk immediately before the end face 34b on the rotation direction side.

The shearing heat generation of the oil film increases as a peripheral speed of the rotary shaft 100 increases and bearing stress on the sliding surface 31 increases. Thus, in the first embodiment, at least one of the bearing pads 30 has the cooling structure described below. The first embodiment describes an example in which all of a plurality of (five) the bearing pads 30 have cooling structures.

### <Cooling Structure of Bearing Pad>

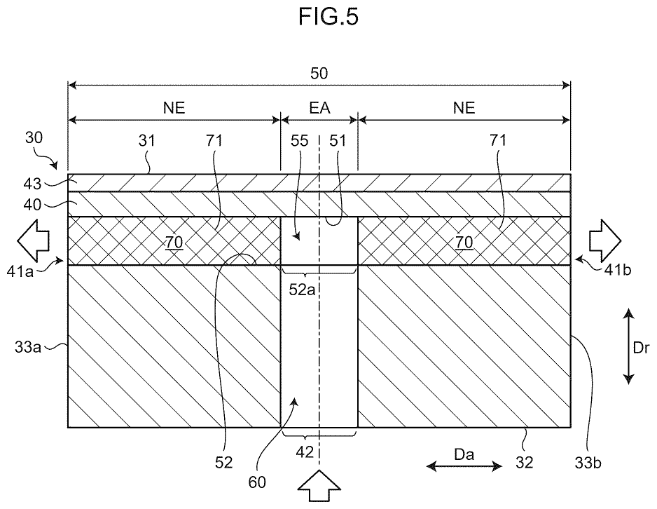

FIG. 4 is a schematic perspective view for explaining a schematic structure of the bearing pad. FIG. 5 is a schematic cross-sectional view for explaining a hollow part of the bearing pad.

In the first embodiment, as illustrated in FIG. 4 and FIG. 5, the bearing pad 30 includes the pad main body 40 including a hollow part 50 and a lubricating oil supply path 60 (refer to FIG. 5). The pad main body 40 has discharge openings 41a and 41b, and an inlet opening 42 on an outer surface.

The pad main body 40 is a structure portion forming an external shape of the bearing pad 30, and is formed of a metallic material (for example, an Fe material or the like). On a surface on an inner peripheral side of the pad main body 40, a sliding material layer 43 (refer to FIG. 5) made of a sliding material (white metal or the like) is disposed. A surface of the sliding material layer 43 constitutes the sliding surface 31. Other outer surfaces of the pad main body 40 respectively constitute the back surface 32, the side surfaces 33a and 33b, and the end faces 34a and 34b of the bearing pad 30 described above.

The hollow part 50 is a cavity formed inside the pad main body 40. The hollow part 50 is partitioned by inner wall surfaces that are formed on an inner side of the outer surfaces described above (the sliding surface 31, the back surface 32, the side surfaces 33a and 33b, and the end faces 34a and 34b) of the pad main body 40.

Specifically, the hollow part 50 at least has a first wall surface 51 on the sliding surface 31 side, a second wall surface 52 on the opposite side of the sliding surface 31 (that is, on the back surface 32 side), and a pair of third wall surfaces 53a and 53b opposed to each other in the circumferential direction. The first wall surface 51 and the second wall surface 52 are inner surfaces opposed to each other in the thickness direction of the pad main body 40 (radial direction Dr). The first wall surface 51 and the second wall surface 52 are flat surfaces, but may be curved corresponding to curves of the sliding surface 31 and the back surface 32. The third wall surface 53a is an inner surface on the end face 34a side, and the third wall surface 53b is an inner surface on the end face 34b side. The third wall surface 53a and the third wall surface 53b are flat surfaces.

The hollow part 50 is formed in a region of the pad main body 40 in the circumferential direction Dc, the region being biased toward the rotation direction side (that is, the end face 34b side) of the rotary shaft 100 in the pad main body 40. The hollow part 50 is disposed within a range of ½ of the entire length from the end face 34b in the circumferential direction Dc. The hollow part 50 is also formed in a range including the peak position Pk in FIG. 3 in the circumferential direction Dc. The peak position Pk can be experimentally obtained by using the bearing pad for testing (refer to FIG. 3) in which the hollow part 50 is not formed, or can be analytically determined by simulation.

The hollow part 50 is an internal space of the pad main body 40 for circulating lubricating oil for cooling. In the hollow part 50, as illustrated in FIG. 5, a supply opening 52a communicating with the lubricating oil supply path 60 is formed on the second wall surface 52. The hollow part 50 communicates with the outside of the pad main body 40 via the discharge openings 41a and 41b.

The hollow part 50 is a space having a substantially rectangular parallelepiped shape extending in the width direction (axial direction Da) of the pad main body 40. In the first embodiment, the hollow part 50 passes through the pad main body 40 in the width direction. That is, both ends in the width direction of the hollow part 50 respectively reach the side surfaces 33a and 33b, which are outer surfaces of the pad main body 40, and are directly (without being connected to another flow path) connected to the discharge openings 41 a and 41b on the side surfaces 33a and 33b. In this manner, the pad main body 40 has the discharge openings 41a and 41b that open on other outer surfaces (the side surfaces 33a and 33b) other than the sliding surface 31, and communicate with the hollow part 50.

The lubricating oil supply path 60 is a flow path formed inside the pad main body 40, and communicates with the hollow part 50. One end of the lubricating oil supply path 60 is connected to the supply opening 52a, and the other end thereof is connected to the inlet opening 42. The inlet opening 42 is an opening part formed on the back surface 32 of the pad main body 40 (bearing pad 30). As illustrated in FIG. 1, the inlet opening 42 is connected to a branch path 12 branched from the nozzle 11 adjacent to the bearing pad 30. Due to this, the inlet opening 42 of the pad main body 40 receives lubricating oil supplied from the oil supply device 110 (refer to FIG. 2) in parallel with the nozzle 11 in a vicinity. Thus, as illustrated in FIG. 5, the lubricating oil supplied from the lubricating oil supply path 60 through the inlet opening 42 flows into the hollow part 50 via the supply opening 52a, passes through the hollow part 50, and is discharged to the outside of the pad main body 40 through the discharge openings 41a and 41b.

The supply opening 52a is formed at a substantially center of the pad main body 40 in the width direction (axial direction Da) of the pad main body 40. The supply opening 52a is arranged in line with the inlet opening 42 along the thickness direction (radial direction Dr) of the pad main body 40. The lubricating oil supply path 60 linearly connects the inlet opening 42 and the supply opening 52a.

### <Internal Structure of Hollow Part>

The hollow part 50 includes a support structure 70 and a space part 55 inside.

The support structure 70 connects the first wall surface 51 and the second wall surface 52 inside the hollow part 50. Due to this, the support structure 70 has a function of reinforcing mechanical strength of the pad main body 40 in the hollow part 50. The support structure 70 includes a plurality of pillar-shaped or plate-shaped support parts 71 that are arranged with a gap therebetween in the hollow part 50. Accordingly, the support structure 70 allows the lubricating oil to circulate in the hollow part 50 through the gap between the support parts 71, while making surfaces of the support parts 71 function as heat transfer surfaces with respect to the lubricating oil. That is, the support structure 70 has a function as a cooling member that transfers heat from the sliding surface 31 into the hollow part 50 via the first wall surface 51, and dissipates the heat to the lubricating oil through contact with the lubricating oil. For convenience, FIG. 5 illustrates the support parts 71 in a lattice shape intersecting obliquely, but a specific structure example of the support structure 70 (the support parts 71) will be described later.

The support structure 70 is disposed in a non-formation region NE of the supply opening 52a in the hollow part 50. In FIG. 5, the non-formation region NE of the supply opening 52a corresponds to a region extending from a peripheral part of the supply opening 52a to the discharge opening 41a (side surface 33a), and a region extending from the peripheral part of the supply opening 52a to the discharge opening 41b (side surface 33b). The support structure 70 may be disposed in only part of the non-formation region NE. In FIG. 5, the support structure 70 is disposed in each non-formation region NE extending from a position adjacent to the space part 55 to each of the discharge openings 41 a and 41b in the hollow part 50.

The space part 55 is a linear space extending from the supply opening 52a to the first wall surface 51 in a formation region EA of the supply opening 52a, which is a space where the support structure 70 is not formed. The space part 55 is formed as a pillar-shaped space in which an opening cross-sectional shape of the supply opening 52a is extended to the first wall surface 51 as it is. That is, in a case where the supply opening 52a has a circular shape, for example, the space part 55 is a cylindrical space. The space part 55 linearly extends to the first wall surface 51 along a center axis (refer to a dot-and-dash line) of the lubricating oil supply path 60 connected to the supply opening 52a. In the example of FIG. 5, the center axis of the lubricating oil supply path 60 is substantially orthogonal to the first wall surface 51 facing the supply opening 52a.

The space part 55 is a space in which not only the support structure 70 but also other structures other than the support structure 70 are not formed. That is, in the space part 55, there is substantially no structure that comes into contact with the lubricating oil flowing from the supply opening 52a into the hollow part 50. Thus, the space part 55 allows the lubricating oil flowing from the supply opening 52a to travel straight and directly collide with a portion of the first wall surface 51 opposed to the supply opening 52a.

### <Structure Example of Support Structure>

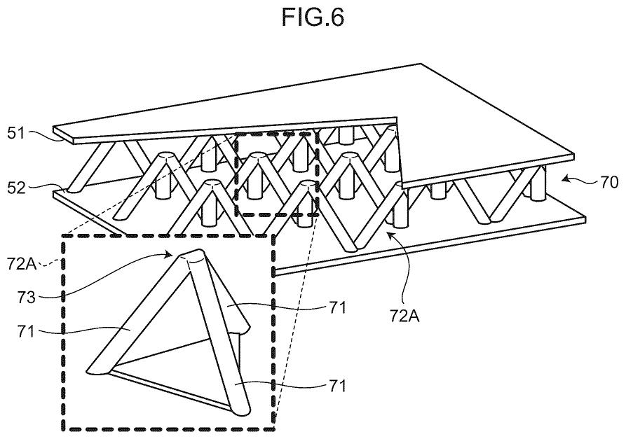

FIG. 6 to FIG. 14 are explanatory diagrams illustrating examples of a unit structure of the support structure 70. The support structure 70 disposed in the hollow part 50 may be any of the structures illustrated in FIG. 6 to FIG. 14, or a combination thereof.

Each support part 71 constituting the support structure 70 has a solid structure. That is, a passage for circulating the lubricating oil is not formed inside each support part 71. The support structure 70 allows the lubricating oil to circulate in a gap between the support parts 71. In FIG. 6 to FIG. 10, the support structure 70 includes a lattice structure constituted of the support parts 71. Herein, the lattice structure means a three-dimensional lattice structure that includes a space therein and is capable of bearing a load in the radial direction Dr in the hollow part 50. As illustrated in FIG. 6, the support structure 70 is formed by arranging a plurality of unit structures constituted of the support parts 71 along the inner wall surface of the hollow part 50.

In the example of FIG. 6, a unit structure 72A of the support structure 70 is constituted of three pillar-shaped support parts 71 whose one ends are connected to each other at a vertex 73. That is, the unit structure 72A is constituted of only edge parts of a tetrahedron. The vertex 73 (one end side) may be connected to the first wall surface 51, or the other end side may be connected to the first wall surface 51.

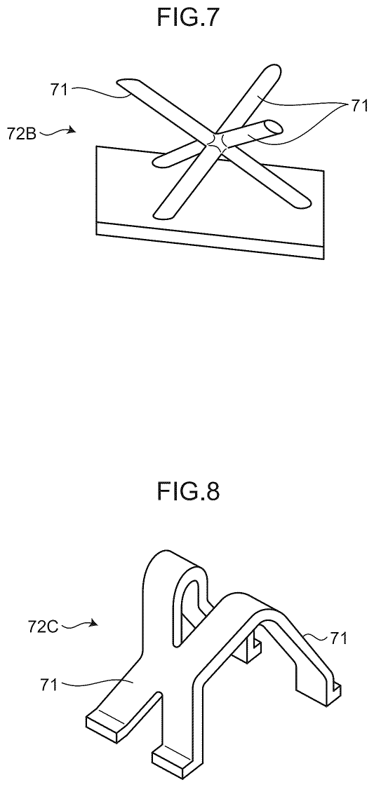

A unit structure 72B illustrated in FIG. 7 is constituted of three pillar-shaped support parts 71 intersecting each other at a middle part. Each end part of the support part 71 may be connected to an end part of the support part 71 of another unit structure 72B adjacent thereto.

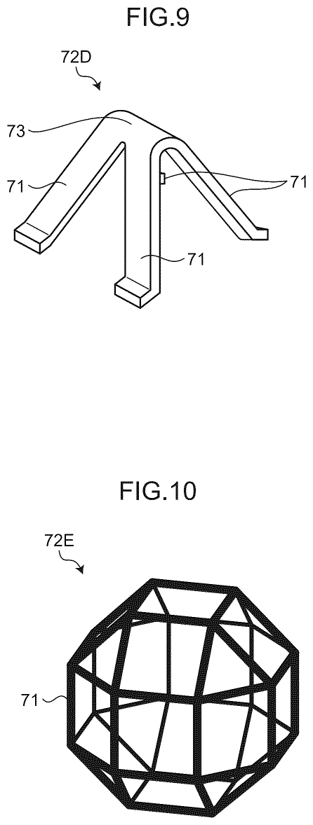

A unit structure 72C illustrated in FIG. 8 has a structure in which two plate-shaped support parts 71 curved in an arch shape are connected to each other at a part between a top part and a bottom part. A unit structure 72D illustrated in FIG. 9 includes four straight plate-shaped support parts 71 whose one ends are connected to each other at the single vertex 73. That is, the unit structure 72D is constituted of only edge parts of a quadrangular pyramid. A unit structure 72E illustrated in FIG. 10 includes a plurality of the pillar-shaped support parts 71 constituting edge parts of a polyhedron. In an arrangement of unit structures 72E, the unit structures 72E adjacent to each other may share some of the support parts 71. Although not illustrated, the support structure 70 can be formed by using a three-dimensional structure called a porous lattice structure.

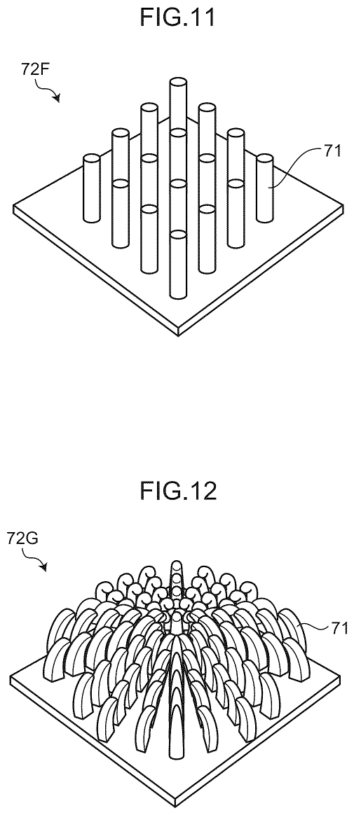

The support structure 70 may be constituted of a unit structure other than the lattice structure. A unit structure 72F in FIG. 11 includes a pin row in which a plurality of pin-shaped support parts 71 are arranged. A unit structure 72G in FIG. 12 includes a plurality of pillar-shaped support parts 71 each extending in the radial direction Dr while being curved in an in-plane direction, and forms a tree-like structure (a shape like densely gathered branches) as a whole.

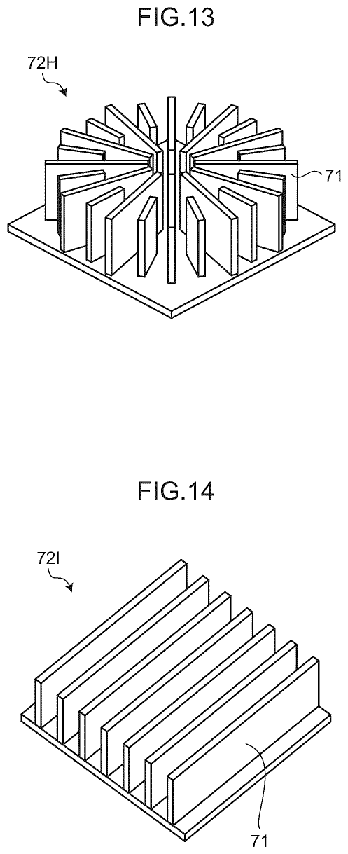

A unit structure 72H in FIG. 13 has a structure in which a plurality of flat plate-shaped (fin-shaped) support parts 71 each extending in the radial direction Dr are arranged to radially extend from the center in the in-plane direction. A center part of the unit structure 72H corresponds to the space part 55 described above. A unit structure 72I in FIG. 14 has a structure (parallel plate structure) in which a plurality of flat plate-shaped support parts 71 each extending in the radial direction Dr are arranged in parallel at intervals in the in-plane direction. The support part 71 of the unit structure 72I extends in the width direction of the pad main body 40 along the hollow part 50.

The support structure 70 constituted of the arrangement of these unit structures 72A to 72I or the like improves structural strength in the hollow part 50, effectively increases a surface area (heat transfer area), and as a result, promotes heat dissipation to the lubricating oil. In the first embodiment, the pad main body 40 is an integrally molded product in which the whole including the hollow part 50, the lubricating oil supply path 60, and the support structure 70 is integrally formed by additive manufacturing (AM).

### <Function of Bearing Device>

The following describes a function of the bearing device 10 according to the first embodiment. As illustrated in FIG. 3, due to shearing heat generation of the oil film accompanying rotation of the rotary shaft 100, a heat generation amount of the bearing pad 30 reaches a maximum at the peak position Pk near a trailing edge part on the rotation direction side (end face 34b side) of the rotary shaft 100. That is, the bearing pad 30 has the maximum heat generation amount at a position of the sliding surface 31 immediately above the hollow part 50 in FIG. 5. The bearing pad 30 cools the heat generated on the sliding surface 31 side by the lubricating oil supplied into the hollow part 50 through the lubricating oil supply path 60.

Herein, the heat generated on the sliding surface 31 side is transferred to the first wall surface 51 of the hollow part 50 via the sliding material layer 43. In the first embodiment, the lubricating oil at a low temperature that has flowed into the hollow part 50 from the supply opening 52a travels straight through the space part 55, and directly collides with the first wall surface 51. By allowing the low-temperature lubricating oil to directly collide with the first wall surface 51 corresponding to a back surface of the sliding surface 31, the bearing pad 30 effectively dissipates heat from the first wall surface 51 (pad main body 40) to the lubricating oil.

When a structure portion such as the support structure 70 is present in the space part 55, although the heat transfer area is increased, the lubricating oil collides with the structure portion before colliding with the first wall surface 51, and its flow velocity is reduced. In the first embodiment, an effect of reducing a peak temperature of the sliding surface 31 is improved by allowing the low-temperature lubricating oil to collide with the first wall surface 51 while maintaining a high flow velocity as compared with a case where a structure portion is present in the space part 55. The presence of the structure portion in the space part 55 causes an increase in flow path resistance. Thus, as compared with a case where a structure portion is present in the space part 55, the first embodiment provides an effect of effectively lowering a temperature of the sliding surface 31 at the peak position Pk while reducing a pressure loss in the hollow part 50.

After colliding with the first wall surface 51, the lubricating oil flows in the hollow part 50, divided into one side and the other side in the width direction, toward the respective discharge openings 41a and 41b through a region in which the support structure 70 is formed. By allowing the lubricating oil after colliding with the first wall surface 51 to collide with an outer surface of the support structure 70 in the hollow part 50, the bearing pad 30 efficiently dissipates the heat transferred from the first wall surface 51 to the support structure 70.

The lubricating oil that has passed through the hollow part 50 and increased in temperature (absorbed heat) is discharged from the discharge openings 41a and 41b on the side surfaces 33a and 33b of the bearing pad 30 to the outside of the bearing pad 30 (that is, an internal space of the housing 20). Since the discharge openings 41a and 41b are formed on the side surfaces 33a and 33b other than the sliding surface 31, the lubricating oil having increased in temperature is prevented from being supplied to a space between the rotary shaft 100 and the sliding surface 31. In the first embodiment, low-temperature lubricating oil from the nozzle 11, rather than lubricating oil that has increased in temperature (absorbed heat) in the hollow part 50, is positively supplied to the space between the rotary shaft 100 and the sliding surface 31, so that cooling performance on the outer surface side of the bearing pad 30 can be secured.

As illustrated in FIG. 2, the lubricating oil discharged from the space between the rotary shaft 100 and the sliding surface 31, and the lubricating oil discharged from the discharge openings 41a and 41b are discharged to the outside of the bearing device 10 through a gap between the flange part 24 and the rotary shaft 100 and a gap between the end face plate 22 and the rotary shaft 100.

### Second Embodiment

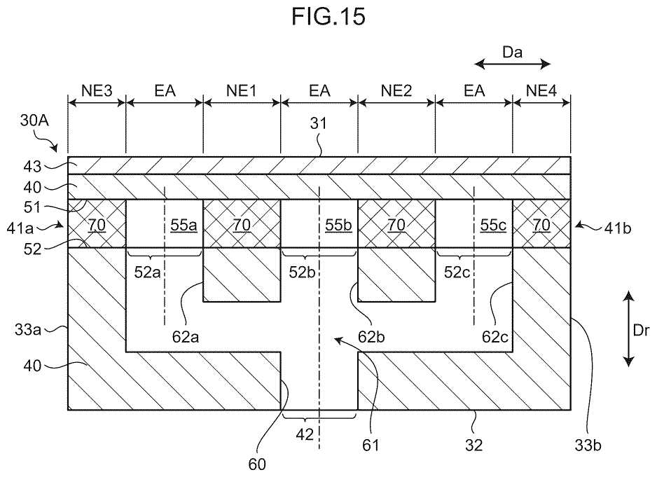

FIG. 15 is a schematic diagram illustrating a structure of the bearing pad of the bearing device according to a second embodiment. A member having the same function as that in the first embodiment described above is denoted by the same reference numeral, and detailed description thereof will not be repeated.

In the first embodiment, an example in which the single supply opening 52a is disposed in the hollow part 50 of the pad main body 40 has been described, whereas the pad main body 40 of a bearing pad 30A according to the second embodiment has a plurality of (three) supply openings 52a, 52b, and 52c on the second wall surface 52. The number of the supply openings is not limited to three, and may be two, or four or more.

The supply openings 52a. 52b, and 52c are arranged at intervals along the width direction (Da direction) of the pad main body 40 on the second wall surface 52. Non-formation regions NE1 and NE2 in which the supply opening 52a is not formed are present between the supply opening 52a and the supply opening 52b, and between the supply opening 52b and the supply opening 52c in the width direction.

The supply openings 52a, 52b, and 52c are connected to the same lubricating oil supply path 60. That is, the lubricating oil supply path 60 is a branched path having one end part connected to the inlet opening 42 and three other end parts respectively connected to the supply openings 52a, 52b, and 52c.

Specifically, the lubricating oil supply path 60 includes passages 62a to 62c each extending from a branch point 61 between the inlet opening 42 and the supply opening 52b. The inlet opening 42 is arranged in line with the supply opening 52b in the thickness direction of the pad main body 40. The passage 62a extends in the width direction from the branch point 61 toward the side surface 33a side, and is bent at a right angle to be connected to the supply opening 52a. The passage 62b extends straight in the thickness direction from the branch point 61 and is connected to the supply opening 52b. The passage 62c extends in the width direction from the branch point 61 toward the side surface 33b side, and is bent at a right angle to be connected to the supply opening 52c. Each of the passages 62a to 62c is connected perpendicularly to the second wall surface 52 (the supply openings 52a to 52c).

In the second embodiment, corresponding space parts 55a, 55b, and 55c are provided for the respective supply openings 52a, 52b, and 52c. Since a center axis of each of the passages 62a to 62c runs along the thickness direction (radial direction Dr) of the bearing pad 30, the space parts 55a, 55b, and 55c are linear spaces extending in the thickness direction from the corresponding supply openings 52a, 52b, and 52c to the first wall surface 51.

The support structure 70 is disposed in the non-formation regions NE1 and NE2 between each pair of the supply openings 52a to 52c in the hollow part 50, excluding the space parts 55a to 55c corresponding to the respective supply openings 52a to 52c. In the second embodiment, the support structure 70 is also disposed in a non-formation region NE3 in the hollow part 50 extending from a position adjacent to the supply opening 52a to the discharge opening 41a (side surface 33a), and in a non-formation region NE4 extending from a position adjacent to the supply opening 52c to the discharge opening 41b (side surface 33b).

Other configurations of the second embodiment are the same as those in the first embodiment described above.

### <Function of Second Embodiment>

In the second embodiment, a plurality of (three) the supply openings 52a to 52c are formed in the hollow part 50 and a plurality of (three) the space parts 55a to 55c are disposed corresponding thereto, so that the lubricating oil that has flowed from each of the supply openings 52a to 52c into the hollow part 50 directly collides with the first wall surface 51 opposed thereto. An area of a region in which the low-temperature lubricating oil directly collides with the first wall surface 51 is increased, so that an effect of reducing a peak temperature of the sliding surface 31 by allowing the low-temperature lubricating oil to collide with the first wall surface 51 is improved. When the lubricating oil passes between the respective supply openings 52a to 52c, the bearing pad 30A is cooled by heat exchange with the support structure 70.

### <Modification of Second Embodiment>

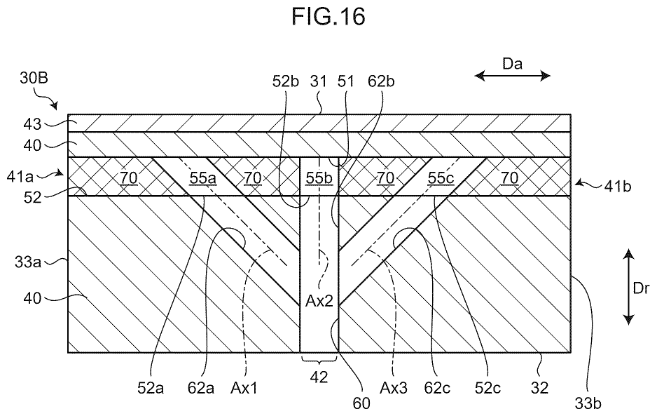

In the example of FIG. 15, all of the passages 62a to 62c of the lubricating oil supply path 60 are connected perpendicularly to the second wall surface 52 (the supply openings 52a to 52c), but the embodiment is not limited thereto. FIG. 16 is a schematic cross-sectional view illustrating a modification of the second embodiment. In a bearing pad 30B according to the modification illustrated in FIG. 16, the passages 62a and 62c are obliquely inclined to be connected to the second wall surface 52 (the supply openings 52a and 52c), respectively.

In this manner, in a case where the lubricating oil supply path 60 is connected obliquely to the second wall surface 52 (the supply opening 52a), the space parts 55a and 55c are also disposed as linear spaces that are obliquely inclined. That is, the space part 55a is formed as a linear space extending from the supply opening 52a to the first wall surface 51 along a center axis Ax1 of the passage 62a. The space part 55c is formed as a linear space extending from the supply opening 52c to the first wall surface 51 along a center axis Ax3 of the passage 62c. Thus, the lubricating oil flowing into the hollow part 50 from the supply opening 52a and the supply opening 52c travels straight through the space parts 55a and 55c, and directly collides with corresponding portions of the first wall surface 51. In this manner, even in a case where the lubricating oil obliquely collides with the first wall surface 51, a cooling effect due to the collision can be sufficiently obtained. A center axis Ax2 of the passages 62b is perpendicular to the second wall surface 52 (supply opening 52b). The lubricating oil supply path 60 (refer to FIG. 5) in the first embodiment described above may also be obliquely inclined. Additionally, the first wall surface 51 and the second wall surface 52 may be non-parallel.

### Working Effect

The bearing device according to a first aspect includes: the bearing pads 30 each having the sliding surface 31 that rotatably supports the rotary shaft 100; and the annular housing 20 that holds the bearing pads 30 arranged in the circumferential direction Dc, wherein at least one of the bearing pads 30 includes the pad main body 40 including the hollow part 50 formed inside, the lubricating oil supply path 60 communicating with the hollow part 50, and the discharge openings 41a and 41b communicating with the hollow part 50. The hollow part 50 has the first wall surface 51 on the sliding surface 31 side and the second wall surface 52 on the opposite side of the sliding surface 31, wherein the supply opening 52a communicating with the lubricating oil supply path 60 is formed on the second wall surface 52. The hollow part 50 includes the support structure 70 that connects the first wall surface 51 and the second wall surface 52 in the non-formation region NE of the supply opening 52a, and includes the space part 55, in which the support structure 70 is not formed, as a linear space extending from the supply opening 52a to the first wall surface 51 in the formation region EA of the supply opening 52a.

The bearing device according to the first aspect can cause the low-temperature lubricating oil that has flowed into the hollow part 50 from the supply opening 52a via the lubricating oil supply path 60 to directly collide with the first wall surface 51 via the space part 55. Due to this, heat of the sliding surface 31 can be effectively dissipated to the low-temperature lubricating oil from the first wall surface 51 of the hollow part 50 corresponding to the back surface of the sliding surface 31. By causing the lubricating oil to collide with the outer surface of the support structure 70 while the lubricating oil that has collided with the first wall surface 51 flows to the discharge openings 41a and 41b, the heat transmitted from the first wall surface 51 to the support structure 70 can be efficiently dissipated. Due to this, for example, as compared with a structure in which the lubricating oil is simply circulated inside the bearing pad 30, cooling performance of the bearing pad 30 can be further improved. As a result, even in a case of using the bearing device 10 under conditions of high peripheral speed and high bearing stress, the temperature of the sliding surface 31 can be prevented from being excessively increased (that is, an upper limit of usable conditions of peripheral speed and bearing stress for the bearing device 10 can be raised).

The bearing device according to a second aspect further includes the nozzle 11 disposed between the bearing pads 30 to supply the lubricating oil to the sliding surface 31 from the outside of the pad main body 40, wherein the discharge openings 41a and 41b are formed on the other outer surfaces other than the sliding surface 31 of the pad main body 40. Due to this, by discharging high-temperature lubricating oil that has passed through the hollow part 50 and absorbed heat from the outer surfaces other than the sliding surface 31, and supplying the low-temperature lubricating oil to the sliding surface 31 (space between the sliding surface 31 and the rotary shaft 100) from the nozzle 11, heat generated by the sliding surface 31 can be absorbed from the outer surface side. Due to this, temperature rise of the sliding surface 31 can be effectively suppressed.

In the bearing device according to a third aspect, the discharge openings 41a and 41b are formed on the side surfaces 33a and 33b in the width direction of the pad main body 40, the hollow part 50 extends in the width direction of the pad main body 40 to be connected to the discharge openings 41a and 41b, and the support structure 70 is disposed in the non-formation region NE extending from the position adjacent to the space part 55 to the discharge openings 41a and 41b in the hollow part 50. Due to this, a range over the entire width of the pad main body 40 can be effectively cooled by the lubricating oil passing through the hollow part 50. Since the hollow part 50 is directly connected to the discharge openings 41 a and 41b, flow path resistance (that is, pressure loss) can be reduced as compared with a case in which the hollow part 50 and the discharge openings 41a and 41b are connected via a narrow flow path.

In the bearing device according to a fourth aspect, the support structure 70 includes the pillar-shaped or plate-shaped support parts 71 arranged with a gap therebetween. Due to this, it is possible to improve the structural strength in the hollow part 50 while effectively increasing the surface area (heat transfer area) of the support structure 70, and to promote heat dissipation to the lubricating oil.

In the bearing device according to a fifth aspect, the support structure 70 includes a lattice structure constituted of the support parts 71. Due to this, it is possible to obtain the support structure 70 having high structural strength and a large surface area (heat transfer area) with a smaller volume (which may also be called weight).

In the bearing device according to a sixth aspect, the pad main body 40 has the inlet opening 42 on the back surface 32 on the opposite side of the sliding surface 31, and the lubricating oil supply path 60 linearly connects the inlet opening 42 and the supply opening 52a. Due to this, a path from the inlet opening 42 to the first wall surface 51 through the lubricating oil supply path 60, the supply opening 52a, and the space part 55 can be linearly shaped. Thus, the lubricating oil can be easily caused to collide with the first wall surface 51 at high flow velocity, so that cooling performance of the bearing pad 30 can be effectively improved.

In the bearing device according to a seventh aspect, the pad main body 40 has the supply openings 52a to 52c on the second wall surface 52, and the support structure 70 is disposed in the non-formation regions NE1 and NE2 between each pair of the supply openings 52a to 52c excluding the space parts 55a to 55c corresponding to the respective supply openings 52a to 52c in the hollow part 50. Since an area of the region in which the low-temperature lubricating oil directly collides with the first wall surface 51 can be increased, a cooling effect by causing the low-temperature lubricating oil to collide with the first wall surface 51 can be further improved. When the lubricating oil passes between each pair of the supply openings 52a to 52c, a cooling effect can be obtained by heat exchange with the support structure 70.

In the bearing device according to an eighth aspect, the hollow part 50 is formed in a region of the pad main body 40 in the circumferential direction Dc, the region being biased toward the rotation direction side of the rotary shaft 100 in the pad main body 40. Due to this, the hollow part 50 can be arranged immediately below a portion of the sliding surface 31 where heat generation particularly increases (refer to the peak position Pk in FIG. 3). That is, the sliding surface 31 at the peak position Pk can be directly cooled by the low-temperature lubricating oil colliding with a portion corresponding to the back side thereof. As a result, a temperature peak of the sliding surface 31 during operation can be effectively reduced. In other words, an allowable upper limit temperature of the sliding surface 31 is less likely to be reached, so that use conditions for the bearing device can be further relaxed (peripheral speed and bearing stress are increased).

### Modification

In the first and the second embodiments described above, described is an example in which the two discharge openings 4la and 41b are formed on the respective side surfaces 33a and 33b of the pad main body 40, but the embodiment is not limited thereto. The discharge opening may be formed on only one of the side surfaces 33a and 33b of the pad main body 40. Alternatively, the discharge opening may be formed on the sliding surface 31, the back surface 32, or the end face 34a or 34b other than the side surfaces 33a and 33b. The discharge openings may be formed at three or more locations.

In the first and the second embodiments, described is an example in which the inlet opening 42 is formed on the back surface 32 of the pad main body 40, but the embodiment is not limited thereto. The inlet opening 42 may be formed on the side surface 33a or 33b other than the back surface 32 of the pad main body 40. A plurality of the inlet openings 42 may be formed at plurality of locations.

In the first and the second embodiments, described is an example in which the hollow part 50 passes through the pad main body 40 in the width direction to be directly connected to the discharge openings 41a and 41b, but the embodiment is not limited thereto. The hollow part 50 may be a space in which both ends in the width direction are partitioned by a pair of fourth wall surfaces (not illustrated). In this case, an opening formed in a part of the fourth wall surface may be connected to the discharge openings 41a and 41b via a flow path for discharge.

In the first and the second embodiments, described is an example in which the bearing device 10 is the journal bearing, but the bearing device may be a thrust bearing. In this case, each bearing pad 30 is arranged along the circumferential direction Dc such that the sliding surface 31 is opposed to an opposed surface (thrust collar) of the rotary shaft in the axial direction Da. In the first and the second embodiments, described is an example in which the bearing device 10 is a tilting pad bearing, but the bearing device may be a fixed pad bearing in which the bearing pads 30 are fixed.

### REFERENCE SIGNS LIST

10 BEARING DEVICE
11 NOZZLE
20 HOUSING
30, 30A BEARING PAD
31 SLIDING SURFACE
32 BACK SURFACE
33a, 33b SIDE SURFACE
40 PAD MAIN BODY
41a, 41b DISCHARGE OPENING
42 INLET OPENING
50 HOLLOW PART
51 FIRST WALL SURFACE
52 SECOND WALL SURFACE
52a, 52b, 52c SUPPLY OPENING
55, 55a, 55b, 55c SPACE PART
60 LUBRICATING OIL SUPPLY PATH
70 SUPPORT STRUCTURE
71 SUPPORT PART
100 ROTARY SHAFT
EA FORMATION REGION
NE, NE1, NE2, NE3, NE4 NON-FORMATION REGION

1. A bearing device comprising:
a plurality of bearing pads each having a sliding surface rotatably supports the rotary shaft; and
an annular housing that holds the bearing pads arranged in a circumferential direction, wherein
at least one of the bearing pads has a pad main body, the pad main body having a hollow part formed inside, a lubricating oil supply path communicating with the hollow part, and discharge openings communicating with the hollow part, and
the hollow part has a first wall surface on the sliding surface side and a second wall surface which is on the opposite side of the sliding surface and on which a supply opening communicating with the lubricating oil supply path is formed,
the hollow part includes a support structure that connects the first wall surface and the second wall surface in a non-formation region of the supply opening,
the hollow part includes a space part in which the support structure is not formed, the space part serving as a linear space extending from the supply opening to the first wall surface in a formation region of the supply opening,
the space part is formed as a pillar-shaped space in which an opening cross-sectional shape of the supply opening is extended to the first wall surface as it is.

2. The bearing device according to claim 1, further comprising:
a nozzle disposed between the bearing pads to supply lubricating oil to the sliding surface from an outside of the pad main body, and
the discharge openings are formed on other outer surfaces other than the sliding surface of the pad main body.

3. The bearing device according to claim 2, wherein
the discharge openings are formed on side surfaces in a width direction of the pad main body,
the hollow part extends in the width direction of the pad main body to be connected to the discharge openings, and
the support structure is disposed in the non-formation region extending from a position adjacent to the space part to the discharge openings in the hollow part.

4. The bearing device according to claim 1, wherein the support structure has a plurality of pillar-shaped or plate-shaped support parts arranged with a gap therebetween.

5. The bearing device according to claim 4, wherein the support structure includes a lattice structure constituted of the support parts.

6. The bearing device according to claim 1, wherein
the pad main body has an inlet opening on a back surface on the opposite side of the sliding surface, and
the lubricating oil supply path linearly connects the inlet opening and the supply opening.

7. The bearing device according to claim 1, wherein
the pad main body has a plurality of the supply openings on the second wall surface, and
the support structure is disposed in the non-formation region between the supply openings excluding a plurality of the space parts corresponding to the respective supply openings in the hollow part.

8. The bearing device according to claim 1, wherein the hollow part is formed in a region of the pad main body in a circumferential direction, the region being biased toward a rotation direction side of the rotary shaft in the pad main body.
